(19) United States
(12) Patent Application Publication
(10) Pub. No.: US 2016/0371679 A1
(43) Pub. Date: Dec. 22, 2016

(54) VIRTUAL CURRENCY TRANSACTION THROUGH PAYMENT CARD

(71) Applicants: Yoshinobu Goto, Denver, CO (US); Chin-Hao Hu, New Taipei City (TW); Ching-Chun Cheng, New Taipei City (TW)

(72) Inventors: Yoshinobu Goto, Denver, CO (US); Chin-Hao Hu, New Taipei City (TW); Ching-Chun Cheng, New Taipei City (TW)

(73) Assignee: WageCan Inc., New Taipei City (TW)

(21) Appl. No.: 15/186,115

(22) Filed: Jun. 17, 2016

Related U.S. Application Data
(60) Provisional application No. 62/180,799, filed on Jun. 17, 2015.

(51) Int. Cl. G06Q 20/36; G06Q 20/34

(52) U.S. Cl. CPC G06Q 20/367; G06Q 20/34; G06Q 2220/00

(57) ABSTRACT

A method of conducting a virtual currency transaction through payment cards, which comprises steps of: a payer providing a payment card with an encrypted address; associating said encrypted address to at least one virtual wallet having crypto currencies; a payee receiving a predetermined amount of crypto currencies from said virtual wallet by scanning the encrypted address; and said payee depositing the crypto currencies into payee's virtual wallet. In one embodiment, the payment card can be, but not limited to a credit card and a debit card. In another embodiment, the crypto currency can be, but not limited to Bitcoin. In a further embodiment, the encrypted address can be shown as, but not limited to a QR code.

### CROSS-REFERENCE TO RELATED APPLICATIONS

This application claims priority under 35 U.S.C. §119 (e) to U.S. Provisional Patent Application Ser. No. 62/180,799, filed on Jun. 17, 2016, which is a continuation in part (CIP) application to U.S. patent application Ser. No. 14/263,850, filed on Apr. 28, 2014, the entire contents of which are hereby incorporated by reference.

### FIELD OF THE INVENTION

The present invention relates generally to a virtual currency payment transaction, and more particularly to a virtual currency payment transaction through a payment card.

### BACKGROUND OF THE INVENTION

The virtual world typically includes an environment with a variety of virtual locations having a variety of virtual objects. In the virtual world, virtual economies are emerging as important aspects of many Internet games and are actually becoming linked with the real world because players of the Internet games may spend real money to buy and sell virtual assets.

Many business entities issue various network virtual currencies to motivate customers and increase their loyalty, as well as Internet game operators who issue many kinds of virtual currencies as common currencies in game worlds. Actually, current network virtual currencies have been widely used in the Internet, for example, they are used to exchange gifts, services, flight tickets, etc. One of the American economists predicts the future virtual economy: “within the daily global financial transactions, only 2% are related to real economy. From 2050, web-based virtual currency will be officially recognized to some extent, and become liquid common currency.” Network virtual currency market is becoming bigger and bigger, and many business opportunities emerge in this area.

Virtual currency systems enable users to interact in the virtual environment by transacting with other entities therein. Users may exchange virtual credits for a variety of different purposes, such as a purchase of goods or services from a vendor or a gift or payment between individuals. In some systems, virtual credits can also be exchanged for real currency, such as purchasing virtual credits with real currency and/or redeeming virtual credits for real currency.

Bitcoins are a form of internet currency. Bitcoins are intangible virtual coins in the form of a file that may be stored on a computer or a computer-related device. Specifically, a Bitcoin (“BTC”) is a unit of currency of a peer-to-peer system that is not regulated by any central or governmental authority. Rather, the regulation of Bitcoins (i.e., the issuance of new Bitcoins and the tracking of transactions involving Bitcoins) may be accomplished collectively by the network of people and businesses that conduct business with Bitcoins.

The use of credit cards for purchasing goods and services has exploded, with a staggering number of credit card transactions performed each day. Given the rapid growth of commerce over the Internet, where credit cards are the preferred method of payment, the number of users and transactions are likely to increase. Credit cards offer convenience to buyers and sellers by facilitating transactions for the purchases of goods and services. However, using the payment cards including but not limited to credit cards, debit cards, etc. to conduct a virtual currency transaction has not been proposed. The combination of the payment cards and virtual currency can be a breakthrough to facilitate virtual currency transaction.

### SUMMARY OF THE INVENTION

It is an object of the present invention to provide a virtual currency transaction system, so the users can conduct virtual currency transactions through payment cards, including but not limited to credit cards, debit cards, etc.

It is another object of the present invention to provide a virtual currency transaction system through payment cards, wherein an encrypted address is provided on the payment card for crypto currencies, and the payee can retrieve the encrypted address to obtain the crypto currencies.

It is a further object of the present invention to provide a virtual currency transaction system to facilitate virtual transactions.

In one aspect, the present invention provides a method of conducting a virtual currency transaction through payment cards, which comprises steps of: a payer providing a payment card with an encrypted address; associating said encrypted address to at least one virtual wallet having crypto currencies; a payee receiving a predetermined amount of crypto currencies from said virtual wallet by retrieving the encrypted address of the payment card; and said payee depositing the crypto currencies into payee's virtual wallet.

In one embodiment, the step of associating said encrypted address to at least one virtual wallet having crypto currencies may include steps of payer generating one or more virtual wallets, and depositing a predetermined amount of crypto currency in said virtual wallets.

In another embodiment, the payment card can be, but not limited to a credit card and a debit card. In a further embodiment, the crypto currency can be, but not limited to Bitcoin. In still a further embodiment, the encrypted address can be shown as, but not limited to a QR code. In still a further embodiment, the way to retrieve the encrypted address includes but not limited to scanning, sensing, sound wave, bluetooth, etc.

In another aspect, a virtual currency transaction system may include a payer terminal and a payee terminal. In the payer terminal, the payer can generate one or more virtual wallets and deposit a predetermined amount of crypto currency in the virtual wallets. The payer terminal can further associate the virtual wallets to a payment card with a cryptographic unit. More specifically, the payer terminal is configured to associate an encrypted address on the cryptographic unit with at least one virtual wallet that has crypto currencies.

The payee system, is configured to receive the predetermined amount of crypto currencies from the payment card. More specifically, the payee system can receive the crypto currencies from the payment card by retrieving the encrypted address associated with the crypto currencies. In one embodiment, the cryptographic unit can be a QR code having the encrypted address therein, and the payee system is configured to scan the QR code to retrieve the encrypted address to obtain the crypto currencies.

In another embodiment, the crypto currency can be, but not limited to Bitcoin. In a further embodiment, the way to retrieve the encrypted address includes but not limited to scanning, sensing, sound wave, bluetooth, etc. The payee system may also include one or more virtual wallets and the crypto currencies received from the payment card can be deposited into the virtual wallets.

### BRIEF DESCRIPTION OF THE DRAWINGS

FIG. 1 is a prior art illustrating Bitcoin transactions.

FIG. 2 illustrates a method of conducting a virtual currency transaction through payment cards in the present invention.

FIG. 2a is one embodiment of the method of conducting a virtual currency transaction through payment cards in the present invention.

FIG. 3 is a schematic view of a payer conducting the virtual currency transaction through payment cards in the present invention.

FIG. 4 is a schematic view of a payee conducting the virtual currency transaction through payment cards in the present invention.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

As discussed above, the environment in the virtual world may be governed, at least in part, by a virtual economy, which typically involves the exchange of virtual currency for real and virtual goods and services. Bitcoins which are intangible virtual coins in the form of a file that may be stored on a computer or a computer-related device, become more and more popular recently. Specifically, Bitcoin uses a peer-to-peer system that is not regulated by any central or governmental authority and enables instant payment to anyone, anywhere in the world.

Bitcoin, introduced in 2009, is called a cryptocurrency. When paying with Bitcoin, no actual monetary exchange takes place between a buyer and a seller. Instead, the buyer requests an update to a public transaction log, the “block chain.” The block chain is a shared public ledger on which the entire Bitcoin network relies and all confirmed transactions are included in the block chain. So, a spendable balance can be calculated in Bitcoin wallets and new transactions can be verified. The integrity and the chronological order of the block chain are enforced with cryptography.

A Bitcoin transaction is a transfer of value between Bitcoin wallets in the block chain. Bitcoin wallets keep a secret piece of data called a private key, which is used to sign transactions, providing a mathematical proof that the signed transactions come from the owner of the wallet. The signature also prevents the transaction from being altered by anybody once it has been issued. All transactions are broadcast between users and usually begin to be confirmed by the network in the following 10 minutes, through a process called mining.

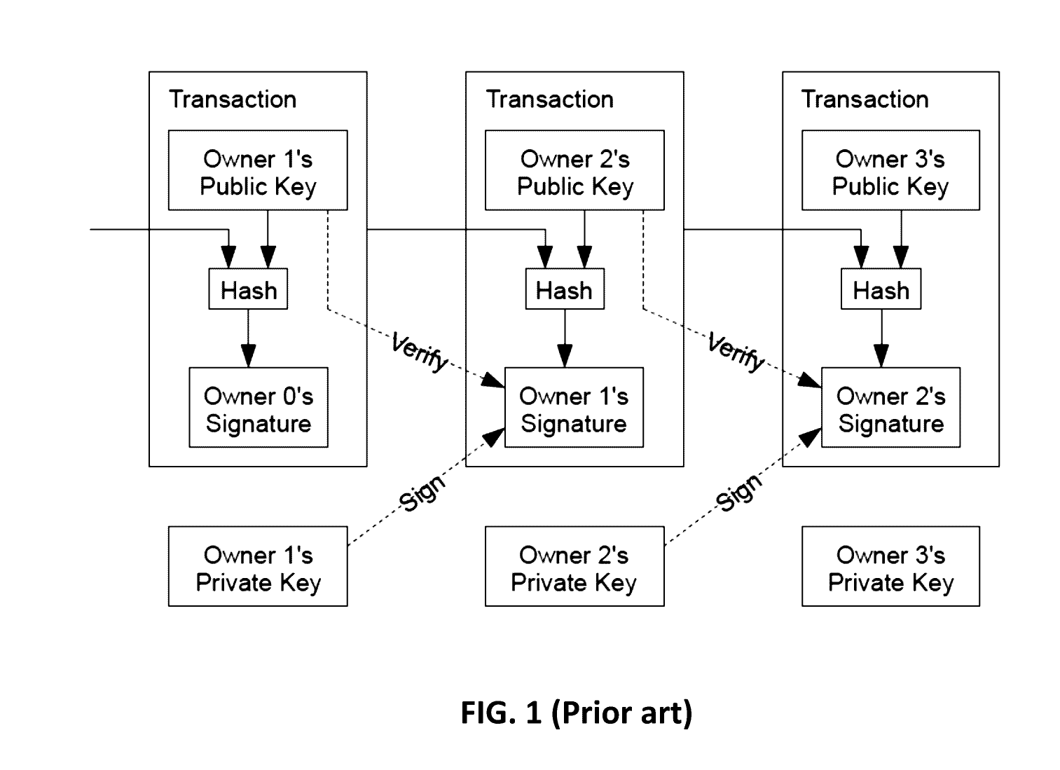

In a nutshell, as shown in FIG. 1, Bitcoin basically functions with one public-key pairing with one private key, and a collection of keys is called Bitcoin wallets. Addresses to which payments can be sent are derived from public keys by application of a hash function and encoding scheme. The corresponding private keys act as a safeguard and a valid payment message from an address must contain the associated public key and be digitally signed by the associated private key. Because anyone with a private key can spend all of the Bitcoins associated with the corresponding address, the essence of Bitcoin security is protection of private keys. However, all these transactions have to be conducted online.

The mining process employs a distributed consensus system that is used to confirm waiting transactions by including them in the block chain. It enforces a chronological order in the block chain, protects the neutrality of the network, and allows different computers to agree on the state of the system. To be confirmed, transactions must be packed in a block that fits very strict cryptographic rules that will be verified by the network. These rules prevent previous blocks from being modified because doing so would invalidate all following blocks. Mining also creates the equivalent of a competitive lottery that prevents any individual from easily adding new blocks consecutively in the block chain. This way, no individuals can control what is included in the block chain or replace parts of the block chain to roll back their own spends.

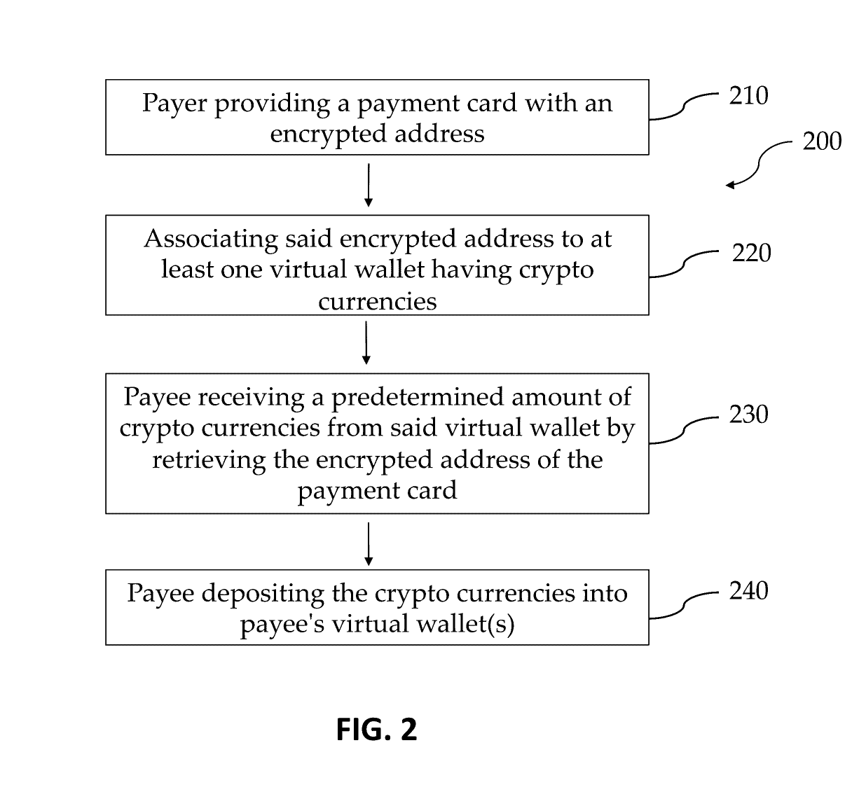

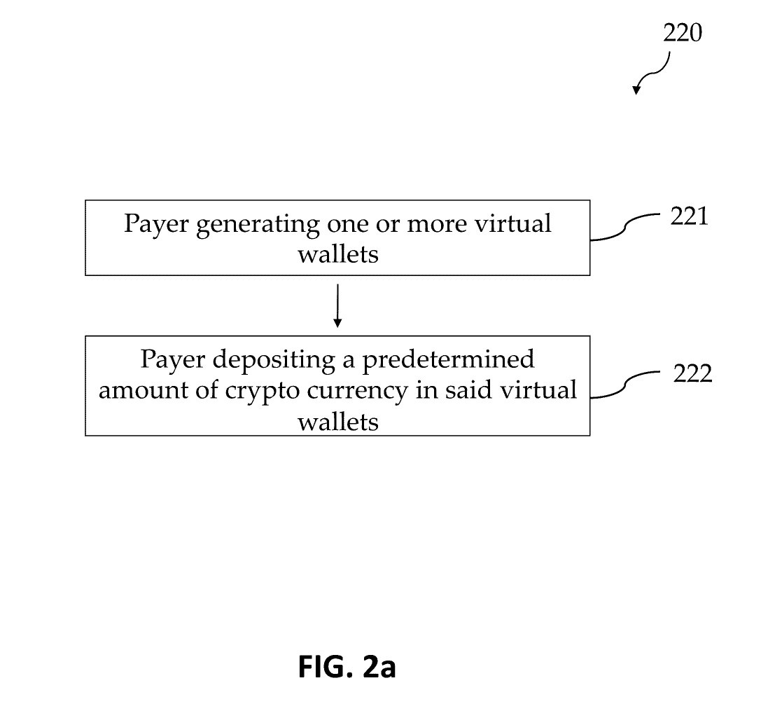

In one aspect, the present invention provides a method (200) of conducting a virtual currency transaction through payment cards, which comprises steps of: a payer providing a payment card with an encrypted address 210; associating said encrypted address to at least one virtual wallet having crypto currencies 220; a payee receiving a predetermined amount of crypto currencies from said virtual wallet by retrieving the encrypted address of the payment card 230; and said payee depositing the crypto currencies into payee's virtual wallet 240, as shown in FIG. 2.

In one embodiment, the step of associating said encrypted address to at least one virtual wallet having crypto currencies 220 may include steps of payer generating one or more virtual wallets 210 and depositing a predetermined amount of crypto currency in said virtual wallets 220.

In another embodiment, the payment card can be, but not limited to a credit card and a debit card. In a further embodiment, the crypto currency can be, but not limited to Bitcoin. In still a further embodiment, the encrypted address can be shown as, but not limited to a QR code. In still a further embodiment, the way to retrieve the encrypted address includes but not limited to scanning, sensing, sound wave, bluetooth, etc.

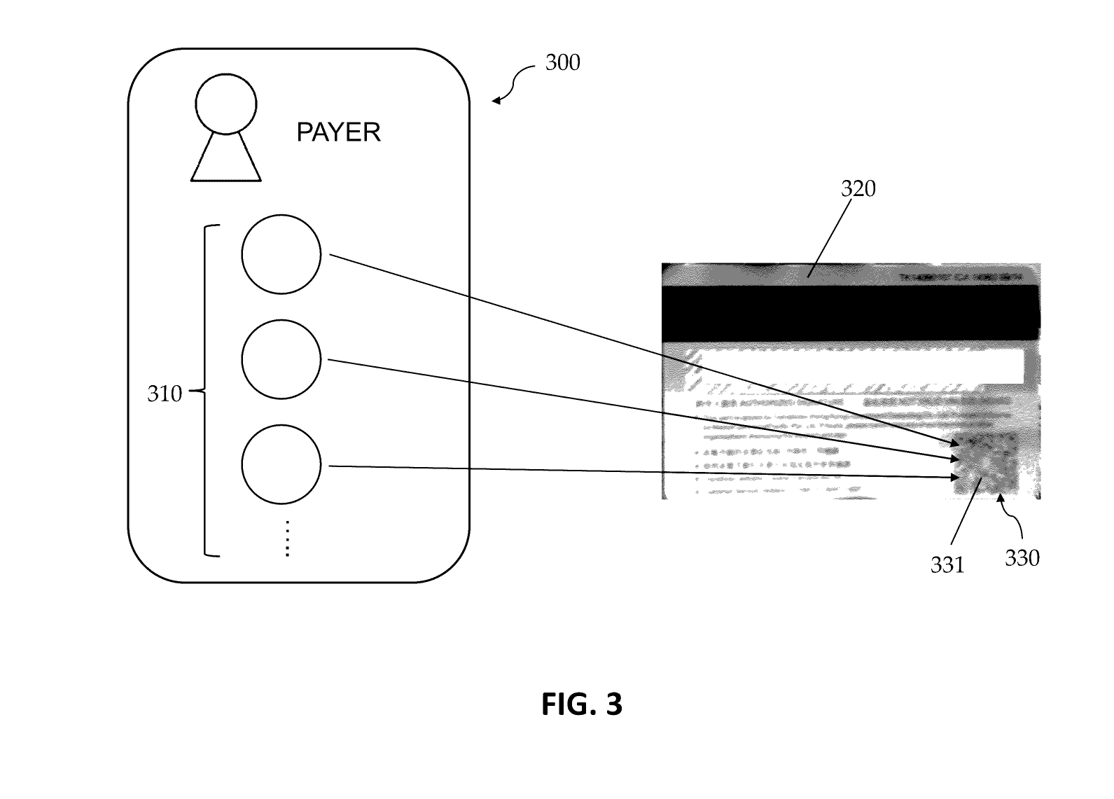

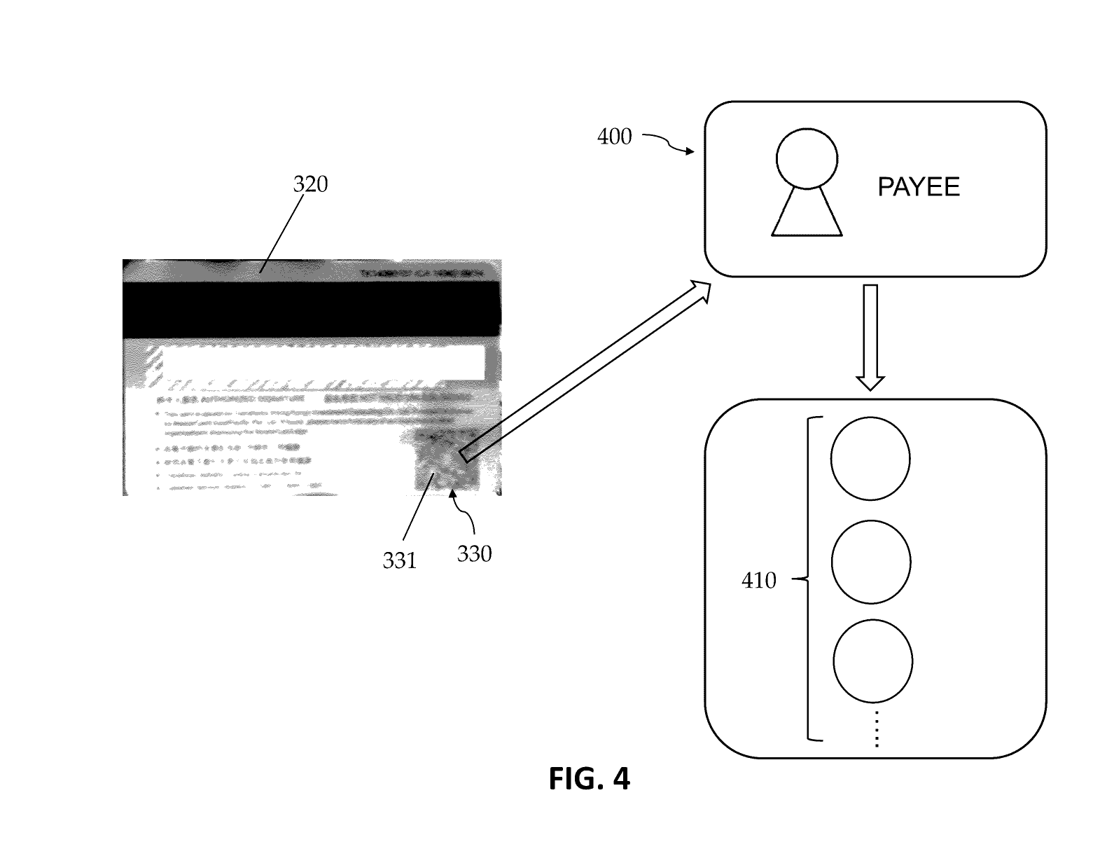

In another aspect as shown in FIGS. 3 and 4, a virtual currency transaction system may include a payer terminal 300 and a payee terminal 400. In the payer terminal 300, the payer can generate one or more virtual wallets 310 and deposit a predetermined amount of crypto currency in the virtual wallets 310. The payer terminal 300 can further associate the virtual wallets 310 to a payment card 320 with a cryptographic unit 330. More specifically, the payer terminal 300 is configured to associate an encrypted address 331 on the cryptographic unit 330 with at least one virtual wallet that has crypto currencies.

The payee system 400, as shown in FIG. 4, is configured to receive the predetermined amount of crypto currencies from the payment card 320. More specifically, the payee system 400 can receive the crypto currencies from the payment card 320 by retrieving the encrypted address 331 associated with the crypto currencies. In one embodiment, the cryptographic unit 330 can be a QR code as shown in FIG. 4 having the encrypted address 331 therein, and the payee system 400 is configured to scan the QR code to retrieve the encrypted address 331 to obtain the crypto currencies.

In another embodiment, the crypto currency can be, but not limited to Bitcoin. In a further embodiment, the way to retrieve the encrypted address 331 includes but not limited to scanning, sensing, sound wave, bluetooth, etc. The payee system 400 may also include one or more virtual wallets 410 and the crypto currencies received from the payment card 320 can be deposited into the virtual wallets 410.

Having described the invention by the description and illustrations above, it should be understood that these are exemplary of the invention and are not to be considered as limiting. Accordingly, the invention is not to be considered as limited by the foregoing description, but includes any equivalents.

What is claimed is:

1. A method of conducting a virtual currency transaction through payment cards, which comprises steps of:
a payer providing a payment card with an encrypted address;
the payer associating said encrypted address to at least one virtual wallet having crypto currencies;
a payee receiving a predetermined amount of crypto currencies from said virtual wallet by retrieving the encrypted address of the payment card; and
said payee depositing the crypto currencies into payee's virtual wallet.

2. The method of conducting a virtual currency transaction through payment cards of claim 1, wherein the step of associating said encrypted address to at least one virtual wallet having crypto currencies includes steps of payer generating one or more virtual wallets, and depositing a predetermined amount of crypto currency in said virtual wallets.

3. The method of conducting a virtual currency transaction through payment cards of claim 1, wherein the payment card is a credit card.

4. The method of conducting a virtual currency transaction through payment cards of claim 1, wherein the payment card is a debit card.

5. The method of conducting a virtual currency transaction through payment cards of claim 1, wherein the crypto currency is Bitcoin.

6. The method of conducting a virtual currency transaction through payment cards of claim 1, wherein the encrypted address is shown as a QR code.

7. The method of conducting a virtual currency transaction through payment cards of claim 1, wherein the encrypted address is retrieved by scanning, sensing, sound wave, Bluetooth.
